(19) United States
(12) Patent Application Publication
(10) Pub. No.: US 2026/0006102 A1
(43) Pub. Date: Jan. 1, 2026

(54) METHODS AND APPARATUS TO ENABLE MESSAGE FILTERING NOTIFICATIONS

(71) Applicant: McAfee, LLC, San Jose, CA (US)

(72) Inventors: Davoud Maha, Danville, CA (US); Lior Rudnik, San Ramon, CA (US)

(21) Appl. No.: 18/756,929

(22) Filed: Jun. 27, 2024

(51) Int. Cl. H04L 67/55; H04L 9/40; H04L 12/18

(52) U.S. Cl. CPC H04L 67/55; H04L 12/1859; H04L 63/0227

(57) ABSTRACT

Systems, apparatus, articles of manufacture, and methods to enable message filtering notifications are disclosed. Example machine readable instructions cause at least one processor circuit to cause storage of a record of a domain name service request transmitted by a user device, the record of the domain name service request including device identifying information to enable identification of the user device, determine whether a message associated with a message filtering request is to be filtered, the message filtering request transmitted by the user device, provide an indication to the user device indicating whether the message is to be filtered, determine whether the message filtering request is temporally correlated with the record of the domain name service request, and cause transmission of a push notification to the user device based on the device identifying information recorded in connection with the domain name service request.

### FIELD OF THE DISCLOSURE

This disclosure relates generally to communications and, more particularly, to methods and apparatus to enable message filtering notifications.

### BACKGROUND

Text messaging, utilizing technologies such as Short Message Service (SMS) messages, enables users of mobile devices to quickly communicate with each other. Sometimes, malicious messages might be sent to a user to try to entice the user to click on a link or perform some other action. That action may be undesirable or even harmful to the user and/or the device they are using.

### BRIEF DESCRIPTION OF THE DRAWINGS

FIG. 1 is a block diagram of an example environment in which an example message filtering server constructed in accordance with teachings of this disclosure operates to provide message filtering notifications.

FIG. 2 is a sequence diagram illustrating communications between a user device and the example message filtering server of FIG. 1.

FIG. 3 is a flowchart representative of example machine readable instructions and/or example operations that may be executed, instantiated, and/or performed by example programmable circuitry to implement the message filtering server 120 of FIG. 1.

FIG. 4 is a block diagram of an example processing platform including programmable circuitry structured to execute, instantiate, and/or perform the example machine readable instructions and/or perform the example operations of FIG. 3 to implement the message filtering server 120 of FIG. 1.

FIG. 5 is a block diagram of an example implementation of the programmable circuitry of FIG. 4.

FIG. 6 is a block diagram of another example implementation of the programmable circuitry of FIG. 4.

FIG. 7 is a block diagram of an example software/firmware/instructions distribution platform (e.g., one or more servers) to distribute software, instructions, and/or firmware (e.g., corresponding to the example machine readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

The use of malicious text messages, also known as “smishing” attacks, has increased in recent history. With more people using smartphones and relying on them for communication, such smartphones (sometimes referred to as mobile devices) have become a prime target for cybercriminals. Mobile devices store sensitive information like bank account details, personal photos, and contacts, making them an attractive target.

SMS messages have a high delivery rate compared to other forms of communication, because such communications are not necessarily reliant on Internet connectivity or email servers. This makes it easier for attackers to reach a large number of potential victims quickly. Users desire ways to block or filter such malicious messages to reduce and/or even prevent the likelihood of opening and/or acting upon a malicious message.

Different approaches for filtering and/or blocking of SMS messages may be utilized on different mobile devices, such as devices operating an iOS operating system from Apple, or devices operating the Android operating system from Google. In some implementations, local analysis may be utilized on a mobile device. As used herein, “local analysis” refers to analysis performed on a user device to which the message is addressed. Local analysis enables the user device to apply rules such as content analysis, sender reputation rules, etc. to determine whether to filter (e.g., block) a message. Filtering a message may cause the message to be placed in a “filtered folder” or in some other location that reduces the likelihood of inadvertent access by a user. Local analysis can sometimes be resource intensive, requiring large rule sets to be stored locally on the device and processed for every message. Moreover, malicious messages are constantly evolving and utilizing new techniques to attempt to cause a user to access malicious content. Updating of such rule sets is typically not performed at a frequency that enables detection of zero-day attacks (e.g., attacks that are detected on the first day in which such attacks are released) and/or other new smishing techniques.

Alternatively, some mobile device systems utilize remote analysis to generate an indication of whether a message should be filtered. Such remote analysis may be facilitated by third-party extensions operated at the user device (e.g., an application, a plugin, etc.) that communicates with a remote entity to perform the remote analysis.

In some implementations, the functionality of those third-party extensions is limited. For instance, in iOS, Apple restricts SMS filtering functionality such that the third-party extension has very limited and controlled communications with external sources. For example, the plugin may be able to provide, to an external server, a request to determine whether a message should be filtered or not, but may not include any personally-identifiable information. For example, the request may include only enough information to enable a response to be provided. Such remote filtering by an external service is more centralized than local analysis approaches and, thus, enables more up-to-date models, filtering techniques, rules, etc. to be utilized to detect whether a message should be filtered than can be expected in the local analysis approach.

In either implementation, in response to a determination that a message is to be filtered, the local SMS filtering functionality (whether implemented entirely locally or by cased on communication with an external service) may perform a responsive action (e.g., allowing the SMS message to be displayed, filtering the SMS message, etc.). Such filtering functionality typically operates in the background and, as such, users may have a message filtered and may not be made aware that the filtering has even taken place. This limits the ability for a user to be notified that a filtered message exists. If users are not aware that filtering is taking place, users may question the value of using such a third-party filtering service.

Examples disclosed herein utilize correlations between domain name service (DNS) request messages received at a server (which may be enhanced to provide device-identifying information) and filtering requests, to enable notifications (e.g., push notifications) to be provided to a device. A DNS request is a request that requests translation of a domain name of a computer into a computer recognizable

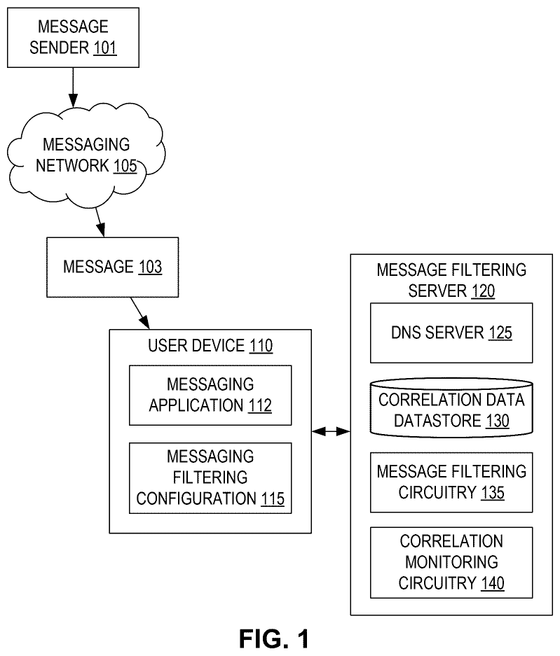

FIG. 1 is a block diagram of an example environment 100 in which an example message filtering server operates to provide/enable message filtering notifications. The example environment 100 includes a message sender 101 that transmits a message 103 via a messaging network 105 to a user device 110. The user device 110 includes a messaging application capable of displaying the message 103 to a user of the user device 110. The messaging application 112 utilizes messaging filtering configuration data 115 to interact with the message filtering server 120. By interacting with the message filtering server 120, the example messaging application 112 determines whether received message 103 should be filtered. If a message is to be filtered, the message may be placed in a folder separate from a folder where the message would be placed if the message were not to be filtered. For example, the message may be placed in a junk folder as opposed to an inbox.

The example message filtering server 120 receives information from the messaging application 112 to determine whether a message is to be filtered. The example message filtering server 120 includes a DNS server 125, a correlation data datastore 130, message filtering circuitry 135, and correlation monitoring circuitry 140. An example implementation of the message filtering server 120 is described in further detail below.

The example message sender 101 of the illustrated example of FIG. 1 is any sender of a message that may be delivered to the example user device 110. In many examples, the example message sender 101 represents a device of another user that is trying to communicate with a user of the user device 110. However, in some situations, the message sender 101 may represent an automated service and/or server that transmits messages to the user device 110. In either case the example message sender 101 may be a malicious actor. For example, the message sender 101 may be trying to scam (e.g., trick) the user of the user device 110 into providing personally identifiable information (PII). Example approaches disclosed herein attempt to identify such malicious messages and protect the user of the user device 110 from the same via mitigation efforts.

The example message 103 of the illustrated example of FIG. 1 is a short message service SMS message. SMS messages are frequently referred to as text messages. SMS messages typically have a maximum length of 160 characters, and are primarily used for sending plain text messages. SMS messages are delivered to the user device using an infrastructure of a cellular network (e.g., the messaging network 105). While SMS messages are described herein, other types of messaging technologies may additionally or alternatively be used. For example, a multimedia messaging service (MMS) message may be used. MMS messages are also typically delivered to the user device 110 via a cellular infrastructure. Additionally or alternatively, rich communication services (RCS) messages may be used. RCS is an evolution of SMS that aims to provide a more enhanced messaging experience for users and supports features like group messaging, high-resolution images, videos, read receipts, typing indicators, etc. RCS messages are typically sent over a data connection (e.g., the Internet), rather than through traditional cellular infrastructure.

Furthermore, other messaging technologies that do not rely on cellular infrastructure may additionally or alternatively be used including, for example, instant messaging apps (e.g., WhatsApp, Facebook messenger, signal, telegram, WeChat, etc.), email messaging, voice calling applications (e.g., Skype, Google meet, Zoom, FaceTime, etc.), social media messaging applications (e.g., Facebook, Twitter, Instagram, Snapchat, etc.).

The example messaging network 105 of the example shown in FIG. 1 represents an infrastructure for delivering the message 103 to the user device 110. The messaging network 105 may be implemented using, for example, cellular infrastructure that enables communication of messages such as SMS messages without the need for a data connection. Additionally or alternatively, the messaging network 105 may be implemented using a data connection, such as a connection to the Internet (e.g. which may or may not be provided by the cellular infrastructure). In other words, the example message 103 may be of any type conveyable electronically and/or may be delivered to the user device 110 in any fashion using any type(s) of messaging protocols.

The example user device 110 of the illustrated example of FIG. 1 represents a mobile device that is operated by a user such as, for example, a smartphone. However, any other type(s) and/or form factor(s) of device(s) may additionally or alternatively be used including, for example, a tablet, a laptop, an all-in-one PC, an IoT device, etc. In examples disclosed herein, the example user device 110 executes an operating system such as iOS from Apple. In some examples, the user device utilizes remote message filtering services which may be triggered by the OS to communicate with a remote server such as the message filtering server 120. The remote server can provide instructions to the user device 110 concerning whether a message is to be filtered. However, any other system (e.g., any other operating system) may additionally or alternatively be used including, for example, a Windows operating system, a Linux operating system, an Android operating system, etc.

The example message filtering server 120 receives messages including a DNS request and a message filtering request from the user device 110. The DNS request is a message that requests translation (e.g., resolution) of a domain name into an address. The message filtering request is a message that requests an indication of whether a message (e.g., a received SMS message, which may be included in a payload of the message filtering request) should be filtered. The example message filtering server 120 analyzes and attempts to correlate these requests based on, for example, the time of receipt of these messages. If a correlation between the DNS request and the message filtering request (and, in some examples, when the message filtering request resulted in the message being filtered/blocked), the example message filtering server 120 may communicate with the user device (e.g., via a push notification) to inform the user of the user device 110 of the results of the message filtering request (e.g., that the message was filtered/blocked).

The message filtering server 120 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the message filtering server 120 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

As noted above, the example message filtering server 120 of FIG. 1 includes the DNS server 125, the correlation data datastore 130, the message filtering circuitry 135, and the example correlation monitoring circuitry 140.

The example DNS server 125 of the illustrated example of FIG. 1 responds to DNS requests by translating domain names into IP addresses and providing the same to requesting devices (e.g., the user device 110 that sent the DNS request). When the user device 110 sends a DNS request message to request an address of a website (which may sometimes be identified using a human-readable domain name (e.g., www.mcafee.com)), the DNS server 125 resolves the domain name of that website into a corresponding IP address and returns the IP address.

In examples disclosed herein, the DNS server 125 communicates using DNS over HyperText Transfer Protocol Secure (DoH) or, alternatively, DNS over Transport Layer Security (DoT). The use of such protocols enables DNS messages to be transmitted in a secure manner and, in some examples, enables additional information to be included in and/or provided with the DNS request. For example, a device identifier may be included with the DNS request (e.g., in a payload of the DNS request message, in a header of the DNS request message). While such protocols are utilized in the examples disclosed herein, any other protocol that enables the inclusion of additional information, such as the device identifier may additionally or alternatively be used.

When the DNS server 125 receives a DNS request, in addition to responding to the DNS request (e.g., by providing the requested IP address information to the originator of the request), the DNS server 125 extracts the device identifier (e.g., that was included in the DNS message by the user device 110) and stores the extracted device identifier in the correlation data datastore 130. In some examples, the DNS server 125 stores a timestamp of the DNS request in the datastore 130 in association with the DNS request record. Such a timestamp may represent a time associated with the DNS request and/or a time associated with a response to the DNS request (e.g., a time at which the DNS request originated from the user device 110, a time at which the DNS request was received at the DNS server 120, a time at which the response message was transmitted to the user device 110 by the DNS server, an anticipated time at which the response message would be received by the user device 110, etc.)

In some examples, multiple timestamps may be recorded. For example, a first time representing the time at which the DNS request originated from the user device 110, a second time at which the DNS request was received at the DNS server 125, and a third time at which the response message was transmitted by the DNS server 125 may be recorded. Recording these three times enables a difference between the first time and the second time to be added to the third time to estimate a fourth time at which the response message was likely to be received at the user device 110. In some examples, the correlation monitoring circuitry 140 may use this fourth time when determining whether a subsequently received message filtering request is time-correlated with a DNS request. Because a user device is likely to quickly transmit a message filtering request after receipt of the response to the DNS request, estimating such times may allow for shorter time correlation windows and/or thresholds to be used, thereby increasing the likelihood that unique DNS request records may be identified in association with subsequent message filtering requests.

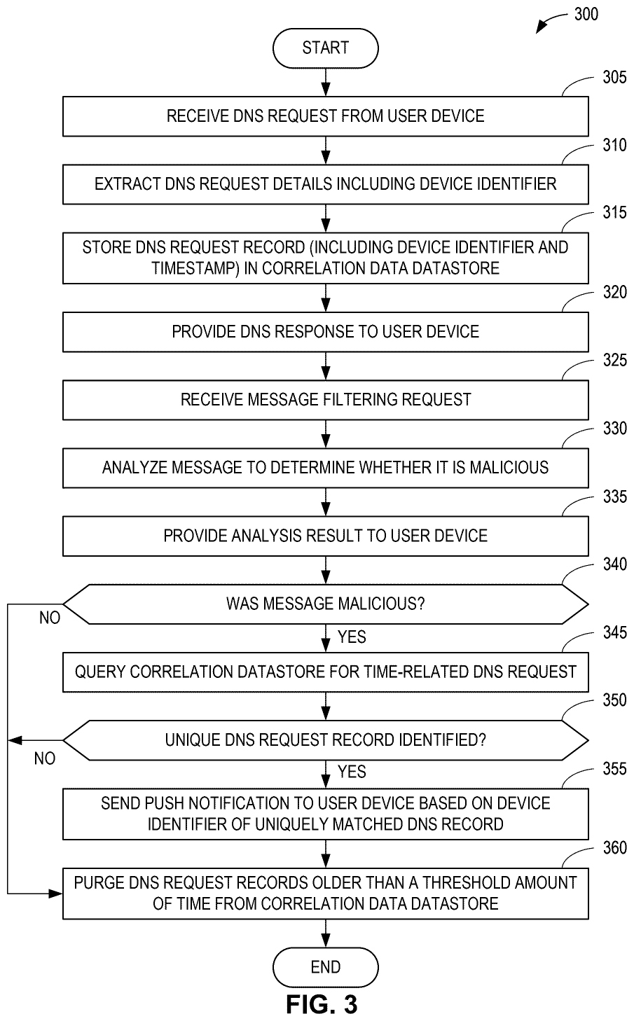

In some examples, the DNS server 125 is instantiated by programmable circuitry executing DNS server instructions and/or configured to perform operations such as those represented by the flowchart of FIG. 3.

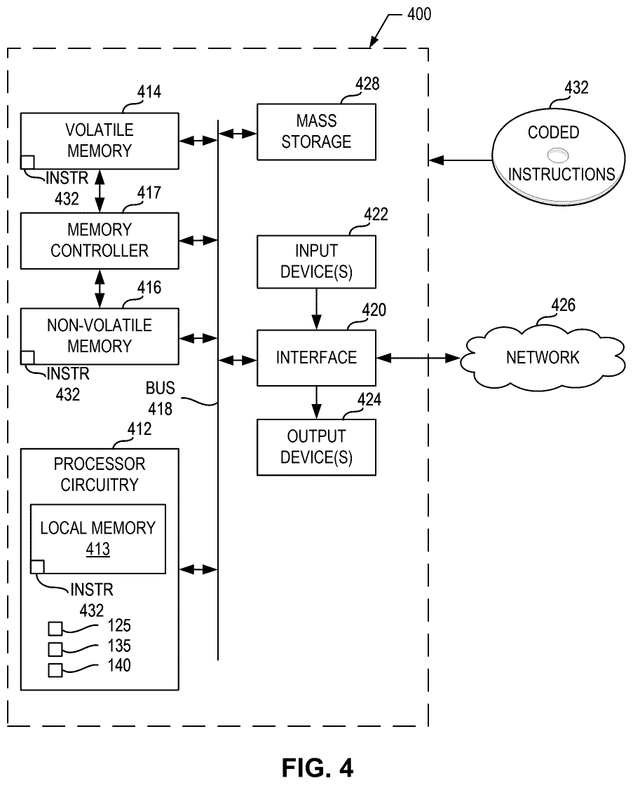

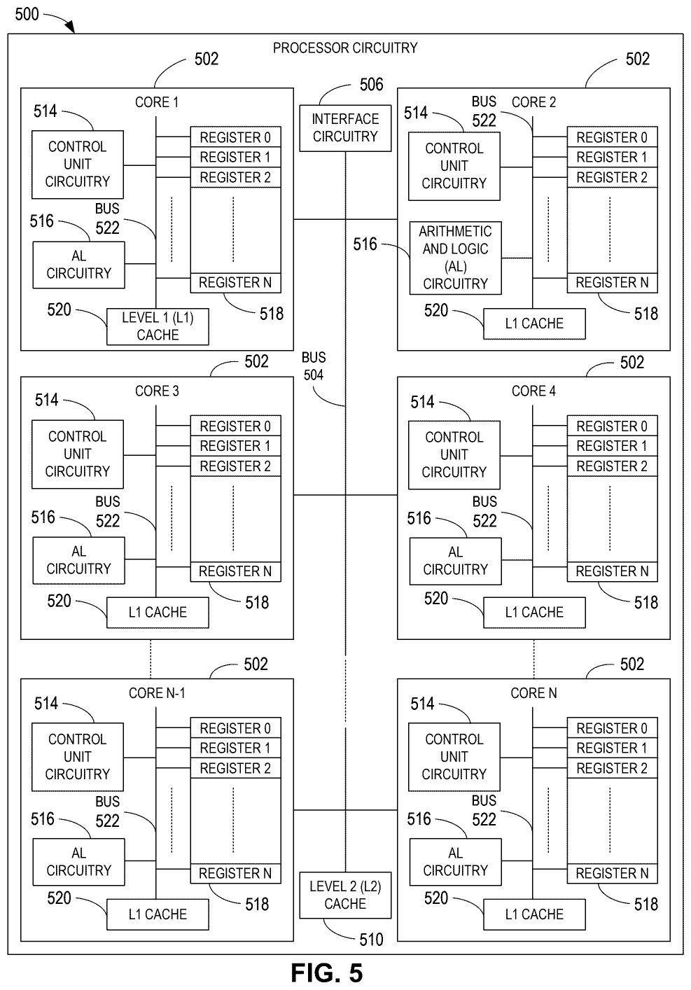

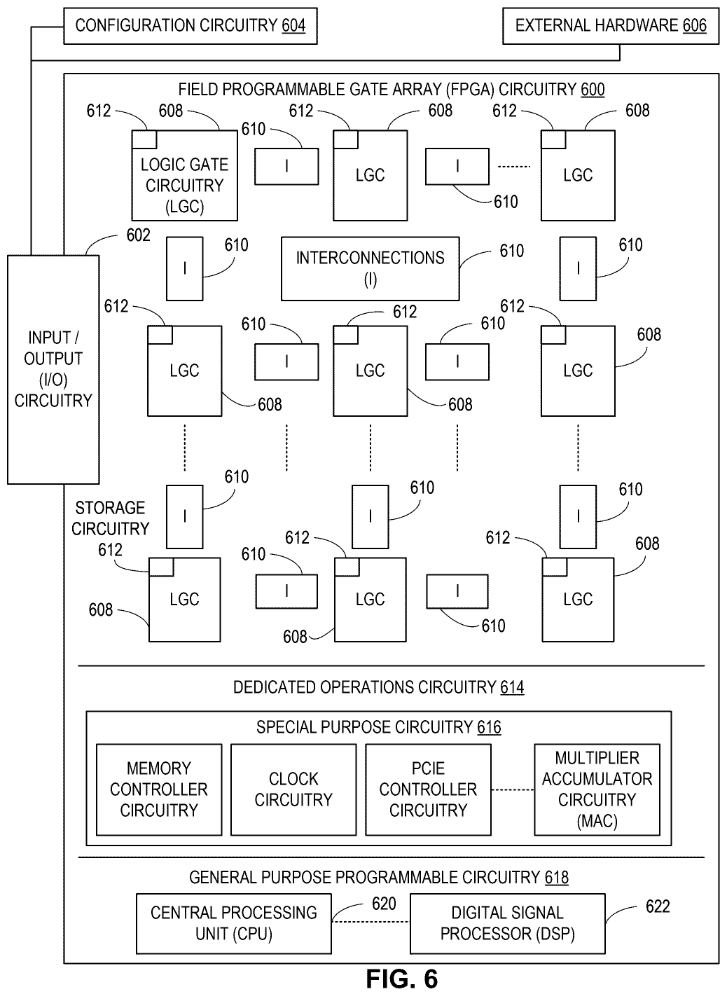

In some examples, the message filtering server 120 includes means for resolving a domain name. For example, the means for resolving a domain name may be implemented by DNS server 125. In some examples, the DNS server 125 may be instantiated by programmable circuitry such as the example programmable circuitry 412 of FIG. 4. For instance, the DNS server 125 may be instantiated by the example microprocessor 500 of FIG. 5 executing machine executable instructions such as those implemented by at least blocks 310, 315, 320, 325 of FIG. 3. In some examples, the DNS server 125 may be instantiated by hardware logic circuitry, which may be implemented by an ASIC, XPU, or the FPGA circuitry 600 of FIG. 6 configured and/or structured to perform operations corresponding to the machine readable instructions. Additionally or alternatively, the DNS server 125 may be instantiated by any other combination of hardware, software, and/or firmware. For example, the DNS server 125 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example correlation data datastore 130 of the illustrated example of FIG. 1 is implemented by any memory, storage device and/or storage disc for storing data such as, for example, flash memory, magnetic media, optical media, solid state memory, hard drive(s), thumb drive(s), etc. Furthermore, the data stored in the example correlation data datastore 130 may be in any data format such as, for example, binary data, comma delimited data, tab delimited data, structured query language (SQL) structures, etc. While, in the illustrated example, the correlation data datastore 130 is illustrated as a single device, the example correlation data datastore 130 and/or any other data storage devices described herein may be implemented by any number and/or type(s) of memories. In the illustrated example of FIG. 1, the example correlation data datastore 130 stores DNS request records and information associated therewith (e.g., timestamps, device identifiers, etc.).

The example message filtering circuitry 135 of the illustrated example of FIG. 1 receives a message analysis request from the user device 110 and determines whether the message received at the user device 110 is malicious. In examples disclosed herein, the message filtering request provides only enough information to enable the message filtering circuitry 135 to provide a response to the user device 110, and does not enable the message filtering circuitry 135 to uniquely identify the user device 110 (e.g., does not include PII). As a result, while the message filtering circuitry 135 can reply to the message filtering request, the message filtering circuitry 135 does not know an identity of the user device 110 and cannot transmit a push notification to the user device to alert the user to the message filtering activity (absent additional information).

In some examples, the message filtering circuitry 135 interacts with other systems to determine whether to classify a message as malicious. For example, the message filtering circuitry 135 may provide the contents of the message (e.g., as received via the message filtering request) to a classification system. This classification system may execute policy-based logic, artificial intelligence, machine learning models, etc. to determine whether a message is malicious. Moreover, because this classification system is centralized, it can be updated more efficiently and quickly than if the user device were attempting to perform such classification via local analysis. In other words, new threats and/or malicious behaviors can be detected (e.g., zero-day attacks), and be prevented. The determination of whether a message is malicious is provided to the message filtering circuitry 135 by the classification system to enable the message filtering circuitry 135 to reply to the message filtering request (e.g., to the user device 110). However, while the message filtering circuitry 135 can reply to the message filtering request, the message filtering circuitry 135 does not know an identity of the user device 110 and cannot transmit a push notification to the user device to alert the user to the message filtering activity (absent additional information).

In some examples, the message filtering circuitry 135 is instantiated by programmable circuitry executing message filtering instructions and/or configured to perform operations such as those represented by the flowchart of FIG. 3.

In some examples, the message filtering server 120 includes means for filtering. For example, the means for filtering may be implemented by message filtering circuitry 135. In some examples, the message filtering circuitry 135 may be instantiated by programmable circuitry such as the example programmable circuitry 412 of FIG. 4. For instance, the message filtering circuitry 135 may be instantiated by the example microprocessor 500 of FIG. 5 executing machine executable instructions such as those implemented by at least blocks 325, 330, 335, 340 of FIG. 3. In some examples, the message filtering circuitry 135 may be instantiated by hardware logic circuitry, which may be implemented by an ASIC, XPU, or the FPGA circuitry 600 of FIG. 6 configured and/or structured to perform operations corresponding to the machine readable instructions. Additionally or alternatively, the message filtering circuitry 135 may be instantiated by any other combination of hardware, software, and/or firmware. For example, the message filtering circuitry 135 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example correlation monitoring circuitry 140 of the illustrated example of FIG. 1, in response to a notification from the message filtering circuitry 135 that a malicious message has been identified, queries the correlation data datastore 130 for a time-correlated DNS request record that may be stored in the correlation data datastore 130. In examples disclosed herein, the time-correlation is identified based on a time of receipt of the message filtering request received at the message filtering circuitry 135, as compared to one or more timestamps associated with DNS request records stored in the correlation data datastore 130. Based on the presence of a time-correlated DNS request record, the user device 110 may be identified (e.g., using a device identifier stored in association with the DNS request record), allowing the correlation monitoring circuitry 140 to notify the user device 110 of the blocked message. In examples disclosed herein, the correlation monitoring circuitry 140 transmits a push notification to the user device 110 identified based on the device identifier associated with the time-correlated DNS request record. However, any other messaging technology may additionally or alternatively be used.

In some examples, the correlation monitoring circuitry 140 correlation monitoring circuitry 140 is instantiated by programmable circuitry executing correlation monitoring instructions and/or configured to perform operations such as those represented by the flowchart of FIG. 3.

In some examples, the message filtering server 120 includes means for correlating. For example, the means for correlating may be implemented by correlation monitoring circuitry 140. In some examples, the correlation monitoring circuitry 140 may be instantiated by programmable circuitry such as the example programmable circuitry 412 of FIG. 4. For instance, the correlation monitoring circuitry 140 may be instantiated by the example microprocessor 500 of FIG. 5 executing machine executable instructions such as those implemented by at least blocks 345, 350, 355, 360 of FIG. 3. In some examples, the correlation monitoring circuitry 140 may be instantiated by hardware logic circuitry, which may be implemented by an ASIC, XPU, or the FPGA circuitry 600 of FIG. 6 configured and/or structured to perform operations corresponding to the machine readable instructions. Additionally or alternatively, the correlation monitoring circuitry 140 may be instantiated by any other combination of hardware, software, and/or firmware. For example, the correlation monitoring circuitry 140 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

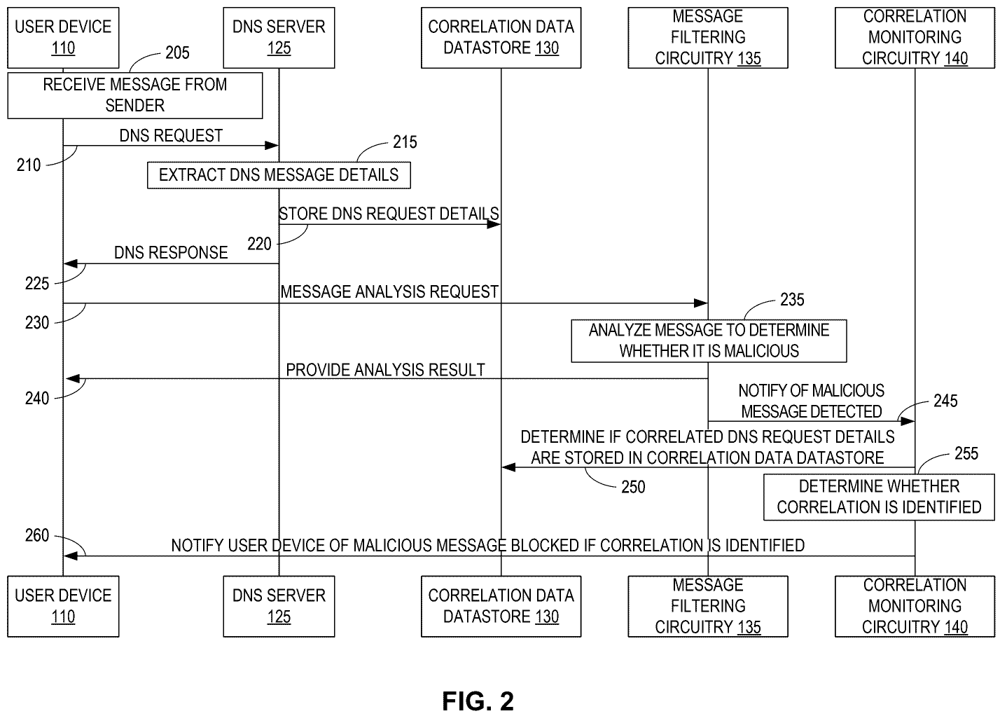

FIG. 2 is a sequence diagram illustrating communications between a user device and the example message filtering server of FIG. 1. The example sequence diagram of FIG. 2 illustrates the communication between the user device 110 and the message filtering server 120, which includes the DNS Server 125, the correlation data datastore 130, the message filtering circuitry 135, and the correlation monitoring circuitry 140. The example sequence of FIG. 2 begins when the user device receives a message from a sender. (Block 205).

The user device 110 then sends a DNS request to the DNS server. (Arrow 210). The DNS server 125 extracts details of the DNS message (block 215) (e.g., a device identifier, a timestamp, etc.) and stores this extracted information in the correlation data datastore. (Arrow 220). The DNS server 125 responds to the DNS request of arrow 210 with a DNS response. (Arrow 225). In some examples, the DNS response includes instructions that the address of the message filtering circuitry 135 is not to be cached at the user device 110, or is only to be allowed to be cached for a very short period of time (e.g., a few seconds). Including such an instruction ensures that when a subsequent message is received at the user device 110, the user device 110 transmits another DNS request to the DNS server 125.

Using the information provided in the DNS response (e.g., an address of the message filtering circuitry 135), the user device 110 then sends a request for message analysis to the message filtering circuitry 135. (Arrow 230). This message analysis request includes the message received from the sender (e.g., the contents of the text message) and, in some examples, additional information associated with the message (e.g., an address of the sender, whether the sender is included in a safe contacts list at the user device, etc.). The message filtering circuitry 135 analyzes the received message analysis request to determine if the message (e.g., the message received at the user device 110) is malicious or not (step 235). The message filtering circuitry 135 provides an analysis result back to the user device 110. (Arrow 240). If the message was identified to be malicious, the message filtering circuitry 135 notifies the correlation monitoring circuitry 140. (Arrow 245). The correlation monitoring circuitry 140, queries the correlation data datastore 130 for a time-correlated DNS request record that may be stored in the correlation data datastore 130. (Arrow 250). The correlation monitoring circuitry 140 determines whether a time-correlated DNS request record is identified. (Block 255). Based on the time-correlated DNS request record, the user device 110 may be identified, allowing the correlation monitoring circuitry 140 to notify the user device 110 of the blocked message. (Arrow 260).

This sequence diagram outlines how the message filtering server 120 can not only determine whether a message is malicious, but also transmit a notification to the user device to alert the user that a malicious message has been blocked.

While an example manner of implementing the message filtering server 120 of FIG. 1 is illustrated in FIG. 1, one or more of the elements, processes, and/or devices illustrated in FIG. 1 may be combined, divided, re-arranged, omitted, eliminated, and/or implemented in any other way. Further, the example DNS server 125, the example message filtering circuitry 135, the example correlation monitoring circuitry 140, and/or, more generally, the example message filtering server 120 of FIG. 1, may be implemented by hardware alone or by hardware in combination with software and/or firmware. Thus, for example, any of the example DNS server 125, the example message filtering circuitry 135, the example correlation monitoring circuitry 140, and/or, more generally, the example message filtering server 120, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example message filtering server 120 of FIG. 1 may include one or more elements, processes, and/or devices in addition to, or instead of, those illustrated in FIG. 1, and/or may include more than one of any or all of the illustrated elements, processes and devices.

A flowchart representative of example machine readable instructions, which may be executed by programmable circuitry to implement and/or instantiate the message filtering server 120 of FIG. 1 and/or representative of example operations which may be performed by programmable circuitry to implement and/or instantiate the message filtering server 120 of FIG. 1, are shown in FIG. 3. The machine readable instructions may be one or more executable programs or portion(s) of one or more executable programs for execution by programmable circuitry such as the programmable circuitry 412 shown in the example processor platform 400 discussed below in connection with FIG. 4 and/or may be one or more function(s) or portion(s) of functions to be performed by the example programmable circuitry (e.g., an FPGA) discussed below in connection with FIGS. 5 and/or 6. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 3, many other methods of implementing the example message filtering server 120 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 3 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to notify a user device of filtered messages. The example machine-readable instructions and/or the example operations 300 of FIG. 3 begin at block 305, a DNS request is received from a user device at the DNS server 125. (Block 310). In examples disclosed herein, this DNS request includes details such as a device identifier of the user device.

The DNS Server 125 extracts details (e.g., the device identifier, etc.) from the DNS request. (Block 310). Such details include a device identifier. The DNS server 125 stores the details (e.g., the device identifier), and a timestamp in the correlation data datastore 130. (Block 315). The DNS server 125 then provides a response to the user device. (Block 325). This response may include information such as the address of the message filtering service that should receive the message filtering request. The response provided to the user device enables the user device to transmit a subsequent message filtering request to the message filtering circuitry 135.

The message filtering circuitry 135 receives the message filtering request. (Block 325). Upon receipt of the message filtering request, the example message filtering circuitry 135 analyzes the content of the message filtering request to determine if the content is malicious or not (Block 330). In some examples, other analysis is performed in addition to or in place of the determination of whether the content is malicious. For example, the example message filtering circuitry 135 may determine whether the message contains unwanted material and/or information, violates a communication policy, etc. The example message filtering circuitry 135 then provides a result of the analysis to the user device. (Block 335). The result of the analysis enables the user device to take action to enable display or non-display of the message. For example, if the message was determined to be malicious (e.g., should be filtered), the example user device may move the message into a particular folder (e.g., a spam folder). Unfortunately, such movement of the message does not typically result in a notification to a user of the user device. Thus, users are frequently unaware that a message has been filtered. This is dis-advantageous, as users might miss important messages that were filtered, might question the value of the filtering service if they are unaware of the amount of filtering that had taken place, etc.

At the messaging filtering server 120, further processing of the message filtering request is performed to enable an alert to be presented to the user. If the message filtering circuitry determines that the message filtering request was identified as malicious (e.g., Block 340 returns a result of YES), the correlation monitoring circuitry 140 queries the correlation data datastore 130 for a time-related DNS request. (Block 345). In examples disclosed herein, the correlation monitoring circuitry 140 queries the correlation data datastore 130 for record of a DNS request that was received no longer than fifty milliseconds prior to receipt of the message filtering request. Using a small window of time ensures unique identification of the message filtering requests. However, any threshold amount of time may additionally or alternatively be used.

The correlation monitoring circuitry 140 determines whether a unique DNS request record is identified. (Block 350). If, for example, multiple DNS request records were stored within the threshold period of time (e.g., fifty milliseconds) such that those multiple DNS request records were identified in response to the query of block 345, then it would be difficult to accurately identify the user device associated with the message filtering request that was identified as malicious. If a unique DNS request record is identified (e.g., block 350 returns a result of YES), the correlation monitoring circuitry 140 transmits a notification (e.g., a push notification) to the user device. (Block 355). In examples disclosed herein, the user device is identified based on the device identifier stored in connection with the DNS request. This push notification enables an alert and/or other type of message to be displayed to the user, informing the user that a message has been filtered.

If, the message is not malicious (e.g., block 340 returns a result of NO), a unique DNS request record cannot be identified (e.g., block 350 returns a result of NO), or after sending of the push notification at block 355, the example correlation monitoring circuitry 140 purges DNS records older than a threshold amount of time from the correlation data datastore 130. (Block 360). The purging of old DNS request records reduces the amount of resources (e.g., memory resources) needed for identification of a user device to which a push notification is to be transmitted. The example process 300 of FIG. 3 then terminates, but may be re-executed in response to, for example, receipt of a subsequent DNS request.

While in the illustrated example of FIG. 3, purging of old DNS request records is illustrated as being performed in a serial fashion after a message filtering request is received, many different approaches for purging of old DNS request records may additionally or alternatively be used. For example, the correlation monitoring circuitry 140 may periodically purge records older than the threshold amount of time (e.g., purge DNS request records that are older than one second every two seconds). In some examples, DNS request records may be deleted if they are found to be associated with a non-malicious message after the message filtering request is received. Deleting DNS request records associated with non-malicious message filtering requests enhances the likelihood that a DNS request record associated with a malicious message can be uniquely identified.

Moreover, while in the illustrated example of FIG. 3, the handling of DNS requests and message filtering requests are illustrated as being executed in a serial fashion, such processes may be treated separately. For example, blocks 305-320 may be handled in parallel with blocks 325-360.

FIG. 4 is a block diagram of an example programmable circuitry platform 400 structured to execute and/or instantiate the example machine-readable instructions and/or the example operations of FIG. 3 to implement the message filtering server 120 of FIG. 1. The programmable circuitry platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, FPGAs, microprocessors, CPUs, GPUs, DSPs, and/or microcontrollers from any desired family or manufacturer. The programmable circuitry 412 may be implemented by one or more semiconductor based (e.g., silicon based) devices. In this example, the programmable circuitry 412 implements the example DNS server 125, the example message filtering circuitry 135, and the example correlation monitoring circuitry 140.

The programmable circuitry 412 of the illustrated example includes a local memory 413 (e.g., a cache, registers, etc.). The programmable circuitry 412 of the illustrated example is in communication with main memory 414, 416, which includes a volatile memory 414 and a non-volatile memory 416, by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416. In some examples, the volatile memory 414 implements the example correlation data datastore 130. However, in some other examples, the mass storage discs or devices 428 may be used to implement the example correlation data datastore 130.

The programmable circuitry platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428 to store firmware, software, and/or data. Examples of such mass storage discs or devices 428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 432, which may be implemented by the machine readable instructions of FIG. 3, may be stored in the mass storage device 428, in the volatile memory 414, in the non-volatile memory 416, and/or on at least one non-transitory computer readable storage medium such as a CD or DVD which may be removable.

FIG. 5 is a block diagram of an example implementation of the programmable circuitry 412 of FIG. 4. In this example, the programmable circuitry 412 of FIG. 4 is implemented by a microprocessor 500. For example, the microprocessor 500 may be a general-purpose microprocessor (e.g., general-purpose microprocessor circuitry). The microprocessor 500 executes some or all of the machine-readable instructions of the flowchart of FIG. 3 to effectively instantiate the circuitry of FIG. 2 as logic circuits to perform operations corresponding to those machine-readable instructions. In some such examples, the circuitry of FIG. 1 is instantiated by the hardware circuits of the microprocessor 500 in combination with the machine-readable instructions. For example, the microprocessor 500 may be implemented by multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowchart of FIG. 3.

The cores 502 may communicate by a first example bus 504. In some examples, the first bus 504 may be implemented by a communication bus to effectuate communication associated with one(s) of the cores 502. For example, the first bus 504 may be implemented by at least one of an Inter-Integrated Circuit (I2C) bus, a Serial Peripheral Interface (SPI) bus, a PCI bus, or a PCIe bus. Additionally or alternatively, the first bus 504 may be implemented by any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2 cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the local memory 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating-point operations. In yet other examples, the AL circuitry 516 may include first AL circuitry that performs integer-based operations and second AL circuitry that performs floating-point operations. In some examples, the AL circuitry 516 may be referred to as an Arithmetic Logic Unit (ALU).

The registers 518 are semiconductor-based structures to store data and/or instructions such as results of one or more of the operations performed by the AL circuitry 516 of the corresponding core 502. For example, the registers 518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure, such as by being distributed throughout the core 502 to shorten access time. The second bus 522 may be implemented by at least one of an I2C bus, a SPI bus, a PCI bus, or a PCIe bus.

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages.

The microprocessor 500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 500, in the same chip package as the microprocessor 500 and/or in one or more separate packages from the microprocessor 500.

FIG. 6 is a block diagram of another example implementation of the programmable circuitry 412 of FIG. 4. In this example, the programmable circuitry 412 is implemented by FPGA circuitry 600. For example, the FPGA circuitry 600 may be implemented by an FPGA. The FPGA circuitry 600 can be used, for example, to perform operations that could otherwise be performed by the example microprocessor 500 of FIG. 5 executing corresponding machine readable instructions. However, once configured, the FPGA circuitry 600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 500 of FIG. 5 described above (which is a general purpose device that may be programmed to execute some or all of the machine readable instructions represented by the flowchart of FIG. 3 but whose interconnections and logic circuitry are fixed once fabricated), the FPGA circuitry 600 of the example of FIG. 6 includes interconnections and logic circuitry that may be configured, structured, programmed, and/or interconnected in different ways after fabrication to instantiate, for example, some or all of the operations/functions corresponding to the machine readable instructions represented by the flowchart of FIG. 3. In particular, the FPGA circuitry 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 3. As such, the FPGA circuitry 600 may be configured and/or structured to effectively instantiate some or all of the operations/functions corresponding to the machine readable instructions of the flowchart of FIG. 3 as dedicated logic circuits to perform the operations/functions corresponding to those software instructions in a dedicated manner analogous to an ASIC. Therefore, the FPGA circuitry 600 may perform the operations/functions corresponding to the some or all of the machine readable instructions of FIG. 3 faster than the general-purpose microprocessor can execute the same.

In the example of FIG. 6, the FPGA circuitry 600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 600 of FIG. 6 may access and/or load the binary file to cause the FPGA circuitry 600 of FIG. 6 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 600 of FIG. 6 to cause configuration and/or structuring of the FPGA circuitry 600 of FIG. 6, or portion(s) thereof.

The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain a binary file, which may be implemented by a bit stream, data, and/or machine-readable instructions, to configure the FPGA circuitry 600, or portion(s) thereof. In some such examples, the configuration circuitry 604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 606 may be implemented by external hardware circuitry. For example, the external hardware 606 may be implemented by the microprocessor 500 of FIG. 5.

The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations/functions that may correspond to at least some of the machine readable instructions of FIG. 3 and/or other desired operations. The logic gate circuitry 608 shown in FIG. 6 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations/functions. The logic gate circuitry 608 may include other electrical structures such as look-up tables (LUTs), registers (e.g., flip-flops or latches), multiplexers, etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example dedicated operations circuitry 614. In this example, the dedicated operations circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the programmable circuitry 412 of FIG. 4, many other approaches are contemplated. For example, FPGA circuitry may include an on-board CPU, such as one or more of the example CPU 620 of FIG. 5. Therefore, the programmable circuitry 412 of FIG. 4 may additionally be implemented by combining at least the example microprocessor 500 of FIG. 5 and the example FPGA circuitry 600 of FIG. 6. In some such hybrid examples, one or more cores 502 of FIG. 5 may execute a first portion of the machine readable instructions represented by the flowchart of FIG. 3 to perform first operation(s)/function(s), the FPGA circuitry 600 of FIG. 6 may be configured and/or structured to perform second operation(s)/function(s) corresponding to a second portion of the machine readable instructions represented by the flowchart of FIG. 3, and/or an ASIC may be configured and/or structured to perform third operation(s)/function(s) corresponding to a third portion of the machine readable instructions represented by the flowchart of FIG. 3.

It should be understood that some or all of the circuitry of FIG. 1 may, thus, be instantiated at the same or different times. For example, same and/or different portion(s) of the microprocessor 500 of FIG. 5 may be programmed to execute portion(s) of machine-readable instructions at the same and/or different times. In some examples, same and/or different portion(s) of the FPGA circuitry 600 of FIG. 6 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 500 of FIG. 5 may execute machine readable instructions in one or more threads executing concurrently and/or in series. In some examples, the FPGA circuitry 600 of FIG. 6 may be configured and/or structured to carry out operations/functions concurrently and/or in series. Moreover, in some examples, some or all of the circuitry of FIG. 1 may be implemented within one or more virtual machines and/or containers executing on the microprocessor 500 of FIG. 5.

In some examples, the programmable circuitry 412 of FIG. 4 may be in one or more packages. For example, the microprocessor 500 of FIG. 5 and/or the FPGA circuitry 600 of FIG. 6 may be in one or more packages. In some examples, an XPU may be implemented by the programmable circuitry 412 of FIG. 4, which may be in one or more packages. For example, the XPU may include a CPU (e.g., the microprocessor 500 of FIG. 5, the CPU 620 of FIG. 6, etc.) in one package, a DSP (e.g., the DSP 622 of FIG. 6) in another package, a GPU in yet another package, and an FPGA (e.g., the FPGA circuitry 600 of FIG. 6) in still yet another package.

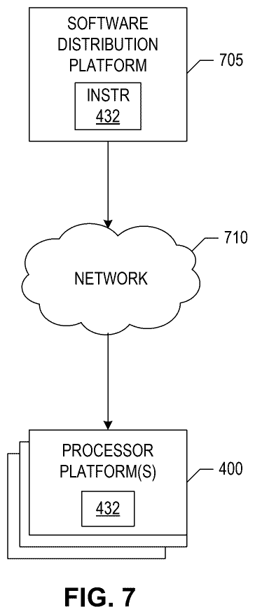

A block diagram illustrating an example software distribution platform 705 to distribute software such as the example machine readable instructions 432 of FIG. 4 to other hardware devices (e.g., hardware devices owned and/or operated by third parties from the owner and/or operator of the software distribution platform) is illustrated in FIG. 7. The example software distribution platform 705 may be implemented by any computer server, data facility, cloud service, etc., capable of storing and transmitting software to other computing devices. The third parties may be customers of the entity owning and/or operating the software distribution platform 705. For example, the entity that owns and/or operates the software distribution platform 705 may be a developer, a seller, and/or a licensor of software such as the example machine readable instructions 432 of FIG. 4. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine readable instructions 432, which may correspond to the example machine readable instructions of FIG. 3, as described above. The one or more servers of the example software distribution platform 705 are in communication with an example network 710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 432 from the software distribution platform 705. For example, the software, which may correspond to the example machine readable instructions of FIG. 3, may be downloaded to the example programmable circuitry platform 400, which is to execute the machine readable instructions 432 to implement the message filtering server 120. In some examples, one or more servers of the software distribution platform 705 periodically offer, transmit, and/or force updates to the software (e.g., the example machine readable instructions 432 of FIG. 4) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable filtering notifications to be provided to a user device. Disclosed systems, apparatus, articles of manufacture, and methods improve the efficiency of using a computing device by enabling message filtering activity and/or determinations to be offloaded from the user device itself, enabling such computation to be performed by devices specialized for such tasks. This enables user devices to be implemented using lower power circuitry, extended battery life, etc. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to enable message filtering notifications are disclosed herein. Further examples and combinations thereof include the following:

Example 1 includes an apparatus comprising interface circuitry, machine-readable instructions, and at least one processor circuit to be programmed by the machine-readable instructions to cause storage of a record of a domain name service request, the domain name service request transmitted by a user device, the record of the domain name service request including device identifying information to enable identification of the user device, determine whether a message associated with a message filtering request is to be filtered, the message filtering request transmitted by the user device, provide an indication to the user device indicating whether the message is to be filtered, determine whether the message filtering request is temporally correlated with the record of the domain name service request, and cause transmission of a push notification to the user device based on the device identifying information recorded in connection with the domain name service request, the push notification to inform a user of the user device that message filtering has occurred.

Example 2 includes the apparatus of any preceding example, wherein the domain name service request is at least one of a domain name service over hypertext transfer protocol secure (DOH) request, or a domain name service over Transport Layer Security (DOT) request.

Example 3 includes the apparatus of any preceding claim, wherein the at least one processor circuit is to cause transmission of the push notification after the determination that the message filtering request is temporally correlated with the record of the domain name service request.

Example 4 includes the apparatus of any preceding example, wherein to determine whether the message filtering request is temporally correlated with the record of the domain name service request one or more of the at least one processor circuit is to determine whether the domain name service request was received within a threshold amount of time before the message filtering request.

Example 5 includes the apparatus of any preceding example, wherein the threshold amount of time is less than or equal to fifty milliseconds.

Example 6 includes the apparatus of any preceding example, wherein to determine whether the message filtering request is temporally correlated with the record of the domain name service request, one or more of the at least one processor circuit is to determine that the domain name service request is an only domain name service request received within the threshold amount of time prior to receipt of the message filtering request.

Example 7 includes the apparatus of any preceding example, wherein the record of the domain name service request is stored in a correlation data datastore, the record to include a device identifier and a timestamp of the domain name service request.

Example 8 includes the apparatus of any preceding example, wherein the record is further to include an internet protocol address and a port associated with the user device.

Example 9 includes the apparatus of any preceding example, wherein one or more of the at least one processor circuit is to cause purging of the record of the domain name service request after a threshold amount of time has elapsed.

Example 10 includes at least one non-transitory machine-readable medium comprising machine-readable instructions to cause at least one processor circuit to at least cause storage of a record of a domain name service request, the domain name service request transmitted by a user device, the record of the domain name service request including device identifying information to enable identification of the user device, determine whether a message associated with a message filtering request is to be filtered, the message filtering request transmitted by the user device, provide an indication to the user device indicating whether the message is to be filtered, determine whether the message filtering request is temporally correlated with the record of the domain name service request, and cause transmission of a push notification to the user device based on the device identifying information recorded in connection with the domain name service request, the push notification to inform a user of the user device that message filtering has occurred.

Example 11 includes the at least one non-transitory machine-readable medium of any preceding example, wherein the domain name service request is at least one of a domain name service over hypertext transfer protocol secure (DOH) requestor a domain name service over Transport Layer Security (DOT) request.

Example 12 includes the at least one non-transitory machine-readable medium of any preceding example, wherein to determine whether the message filtering request is temporally correlated with the record of the domain name service request, the machine-readable instructions are to cause one or more of the at least one processor circuit to determine whether the domain name service request was received within a threshold amount of time before the message filtering request.

Example 13 includes the at least one non-transitory machine-readable medium of any preceding example, wherein to determine whether the message filtering request is temporally correlated with the record of the domain name service request, the machine-readable instructions are to cause one or more of the at least one processor circuit to determine that the domain name service request is an only domain name service request within a threshold amount of time prior to receipt of the message filtering request.

Example 14 includes the at least one non-transitory machine-readable medium of any preceding example, wherein the record of the domain name service request is stored in a correlation data datastore, the record to include a device identifier and a timestamp of the domain name service request.

Example 15 includes the at least one non-transitory machine-readable medium of any preceding example, wherein the machine-readable instructions are to cause one or more of the at least one processor circuit to cause purging of the record of the domain name service request after a threshold amount of time has elapsed.

Example 16 includes a method to enable message filtering notifications, the method comprising storing a record of a domain name service request, the domain name service request transmitted by a user device, the record of the domain name service request including device identifying information to enable identification of the user device, determining whether a message associated with a message filtering request is to be filtered, the message filtering request transmitted by the user device, providing an indication to the user device indicating whether the message is to be filtered, determining whether the message filtering request is temporally correlated with the record of the domain name service request, and causing transmission of a push notification to the user device based on the device identifying information recorded in connection with the domain name service request, the push notification to inform a user of the user device that message filtering has occurred.

Example 17 includes the method of any preceding example, wherein the domain name service request is a domain name service over hypertext transfer protocol secure (DOH) request.

Example 18 includes the method of any preceding example, wherein the domain name service request is a domain name service over Transport Layer Security (DOT) request.

Example 19 includes the method of any preceding example, wherein the determination of whether the message filtering request is temporally correlated with the record of the domain name service request includes determining whether the domain name service request was received within a threshold amount of time before the message filtering request.

Example 20 includes the method of any preceding example, wherein the determination of whether the message filtering request is temporally correlated with the record of the domain name service request includes determining that the domain name service request is an only domain name service request received within a threshold amount of time prior to receipt of the message filtering request.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
cause storage of a record of a domain name service request, the domain name service request transmitted by a user device, the record of the domain name service request including device identifying information to enable identification of the user device;
determine whether a message associated with a message filtering request is to be filtered, the message filtering request transmitted by the user device;
provide an indication to the user device indicating whether the message is to be filtered;
determine whether the message filtering request is temporally correlated with the record of the domain name service request; and
cause transmission of a push notification to the user device based on the device identifying information recorded in connection with the domain name service request, the push notification to inform a user of the user device that message filtering has occurred.

2. The apparatus of claim 1, wherein the domain name service request is at least one of a domain name service over hypertext transfer protocol secure (DOH) request, or a domain name service over Transport Layer Security (DOT) request.

3. The apparatus of claim 1, wherein the at least one processor circuit is to cause transmission of the push notification after the determination that the message filtering request is temporally correlated with the record of the domain name service request.

4. The apparatus of claim 1, wherein to determine whether the message filtering request is temporally correlated with the record of the domain name service request one or more of the at least one processor circuit is to determine whether the domain name service request was received within a threshold amount of time before the message filtering request.

5. The apparatus of claim 4, wherein the threshold amount of time is less than or equal to fifty milliseconds.

6. The apparatus of claim 4, wherein to determine whether the message filtering request is temporally correlated with the record of the domain name service request, one or more of the at least one processor circuit is to determine that the domain name service request is an only domain name service request received within the threshold amount of time prior to receipt of the message filtering request.

7. The apparatus of claim 1, wherein the record of the domain name service request is stored in a correlation data datastore, the record to include a device identifier and a timestamp of the domain name service request.

8. The apparatus of claim 7, wherein the record is further to include an internet protocol address and a port associated with the user device.

9. The apparatus of claim 1, wherein one or more of the at least one processor circuit is to cause purging of the record of the domain name service request after a threshold amount of time has elapsed.

10. At least one non-transitory machine-readable medium comprising machine-readable instructions to cause at least one processor circuit to at least:
cause storage of a record of a domain name service request, the domain name service request transmitted by a user device, the record of the domain name service request including device identifying information to enable identification of the user device;
determine whether a message associated with a message filtering request is to be filtered, the message filtering request transmitted by the user device;
provide an indication to the user device indicating whether the message is to be filtered;
determine whether the message filtering request is temporally correlated with the record of the domain name service request; and
cause transmission of a push notification to the user device based on the device identifying information recorded in connection with the domain name service request, the push notification to inform a user of the user device that message filtering has occurred.

11. The at least one non-transitory machine-readable medium of claim 10, wherein the domain name service request is at least one of a domain name service over hypertext transfer protocol secure (DOH) requestor a domain name service over Transport Layer Security (DOT) request.

12. The at least one non-transitory machine-readable medium of claim 10, wherein to determine whether the message filtering request is temporally correlated with the record of the domain name service request, the machine-readable instructions are to cause one or more of the at least one processor circuit to determine whether the domain name service request was received within a threshold amount of time before the message filtering request.

13. The at least one non-transitory machine-readable medium of claim 10, wherein to determine whether the message filtering request is temporally correlated with the record of the domain name service request, the machine-readable instructions are to cause one or more of the at least one processor circuit to determine that the domain name service request is an only domain name service request within a threshold amount of time prior to receipt of the message filtering request.

14. The at least one non-transitory machine-readable medium of claim 10, wherein the record of the domain name service request is stored in a correlation data datastore, the record to include a device identifier and a timestamp of the domain name service request.

15. The at least one non-transitory machine-readable medium of claim 10, wherein the machine-readable instructions are to cause one or more of the at least one processor circuit to cause purging of the record of the domain name service request after a threshold amount of time has elapsed.

16. A method to enable message filtering notifications, the method comprising:
storing a record of a domain name service request, the domain name service request transmitted by a user device, the record of the domain name service request including device identifying information to enable identification of the user device;
determining whether a message associated with a message filtering request is to be filtered, the message filtering request transmitted by the user device;
providing an indication to the user device indicating whether the message is to be filtered;
determining whether the message filtering request is temporally correlated with the record of the domain name service request; and
causing transmission of a push notification to the user device based on the device identifying information recorded in connection with the domain name service request, the push notification to inform a user of the user device that message filtering has occurred.

17. The method of claim 16, wherein the domain name service request is a domain name service over hypertext transfer protocol secure (DOH) request.

18. The method of claim 16, wherein the domain name service request is a domain name service over Transport Layer Security (DOT) request.

19. The method of claim 16, wherein the determination of whether the message filtering request is temporally correlated with the record of the domain name service request includes determining whether the domain name service request was received within a threshold amount of time before the message filtering request.

20. The method of claim 16, wherein the determination of whether the message filtering request is temporally correlated with the record of the domain name service request includes determining that the domain name service request is an only domain name service request received within a threshold amount of time prior to receipt of the message filtering request.
